(19) United States
(12) Patent Application Publication
(10) Pub. No.: US 2022/0297229 A1
(43) Pub. Date: Sep. 22, 2022

(54) METHOD FOR LASER MATERIAL PROCESSING AND LASER PROCESSING APPARATUS

(71) Applicant: TRUMPF Laser- und Systemtechnik GmbH, Ditzingen (DE)

(72) Inventors: Daniel Flamm, Ludwigsburg (DE); Jonas Kleiner, Leonberg (DE)

(21) Appl. No.: 17/835,994

(22) Filed: Jun. 9, 2022

Related U.S. Application Data
(63) Continuation of application No. PCT/EP2020/086643, filed on Dec. 17, 2020.

(30) Foreign Application Priority Data
Dec. 19, 2019 (DE) 10 2019 135 283.5

(51) Int. Cl. B23K 26/042; B23K 26/00; B23K 26/38; B23K 26/046; B23K 26/06

(52) U.S. Cl. CPC B23K 26/042; B23K 26/0006; B23K 26/38; B23K 26/046; B23K 26/0604

(57) ABSTRACT

A method for laser material processing includes generating a first pulsed laser beam that forms a first focus zone, and processing the material with the first pulsed laser beam in order to produce first modifications. The first modifications form a shielding surface. The method further includes generating a second pulsed laser beam that forms a second focus zone, which is formed in elongated fashion along a second focus zone axis and is formed by constructive interference of laser radiation that passes at an angle toward the second focus zone axis. The method further includes processing the material with the second pulsed laser beam to produce second modifications in a second section of the material. At least one part of the laser radiation passes at the angle toward the second focus zone axis impinges on the shielding surface.

### CROSS REFERENCE TO RELATED APPLICATIONS

This application is a continuation of International Application No. PCT/EP2020/086643 (WO 2021/122894 A1), filed on Dec. 17, 2020, and claims benefit to German Patent Application No. DE 10 2019 135 283.5, filed on Dec. 19, 2019. The aforementioned applications are hereby incorporated by reference herein.

### FIELD

Embodiments of the present invention relate to a method for the laser material processing of an at least partly transparent material by sequentially modifying mutually adjoining sections of the material with pulsed laser beams. Furthermore, embodiments of the present invention relate to a laser processing apparatus.

### BACKGROUND

A workpiece can generally be processed by an interaction of laser radiation with the material of the workpiece, which interaction modifies the material of the workpiece. If laser radiation is absorbed in the volume of the material (so-called volume absorption), localized modifications can be introduced into the material of the workpiece and thus into the interior of the workpiece by the laser radiation. In this case, the workpiece consists of an at least partly transparent material.

### SUMMARY

Embodiments of the present invention provide a method for laser material processing of an at least partly transparent material. The method includes generating a first pulsed laser beam, which when radiated into the material forms a first focus zone, and processing the material with the first pulsed laser beam in order to produce first modifications. The first focus zone is moved relative to the material in order to modify a first section of the material, such that the first modifications form a shielding surface. The method further includes generating a second pulsed laser beam, which when radiated into the material forms a second focus zone, which is formed in elongated fashion along a second focus zone axis and is formed by constructive interference of laser radiation that passes at an angle toward the second focus zone axis. The method further includes processing the material with the second pulsed laser beam by moving the second focus zone relative to the material in order to produce second modifications in a second section of the material. At least one part of the laser radiation passes at the angle toward the second focus zone axis impinges on the shielding surface.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a laser processing apparatus for material processing according to some embodiments;

FIG. 2 shows a schematic 3D illustration of a flat bed laser processing apparatus according to some embodiments;

FIGS. 3, 4, 5, and 6 show schematic illustrations of intensity distributions in elongated focus zones which are based on different types of quasi-Bessel beams according to some embodiments;

FIG. 7A shows a schematic diagram for clarifying a first processing step according to some embodiments;

FIG. 7B shows a schematic diagram for clarifying a second processing step according to some embodiments;

FIG. 7C shows further schematic diagrams for clarifying the second processing step according to some embodiments;

FIG. 7D shows a sectional view through the material after the second processing step has been carried out, for clarifying the resulting modification, according to some embodiments;

FIG. 7E shows a schematic illustration of a resulting workpiece after separation of the material along the modification clarified in FIG. 7D, according to some embodiments;

FIG. 8 shows a schematic illustration of an exemplary workpiece in which the focus zones were not coordinated with one another according to embodiments of the invention;

FIG. 9 shows a schematic diagram for clarifying an alternative sequence of two processing steps according to some embodiments;

FIG. 10A shows a schematic diagram for clarifying material processing with a sequence of three processing steps with elongated focus zones according to some embodiments;

FIG. 10B shows a schematic diagram for clarifying material processing with two processing steps with elongated focus zones and one processing step with Gaussian beam focus zones according to some embodiments; and

FIG. 11 shows a schematic diagram for clarifying an adjustability of the beginning, end and length of a Bessel beam focus zone, according to some embodiments.

### DETAILED DESCRIPTION

Generally, a spatially defined volume absorption can be fostered by a use of nonlinearly induced absorption in which an interaction of the laser radiation with the material takes place only starting from a material-dependent (threshold) intensity. In this case, the material typically has a low linear absorption. Nonlinearly induced absorption is understood herein to mean an intensity-dependent absorption of light which is primarily based not on the direct absorption of the light, but rather on a multiphoton- and/or tunnel-ionization-induced absorption. In this regard, the nonlinearly induced absorption is based on an increase in the absorption during the interaction with the incident light, usually a temporally delimited laser pulse. In this case, as a result of inverse bremsstrahlung, for example, electrons can absorb so much energy that further electrons are released as a result of collisions and the rate of electron production exceeds the rate of recombination. The start electrons required for the absorption that increases in an avalanche-like manner may already be present at the beginning or they can be generated e.g. by way of a (linear) residual absorption present. By way of example, in the case of ns laser pulses, an initial ionization may result in a temperature increase that causes the number of free electrons and thus the subsequent absorption to increase. In the case of sub-ns pulse durations, start electrons can be generated by multiphoton or tunnel ionization as examples of known nonlinear absorption mechanisms.

In the case of materials that are transparent to the laser beam, a volume absorption can be used for forming a modification of the material in an elongated focus zone; see e.g. WO 2016/079062 A1 in the name of the present applicant. Such modifications can enable separating, drilling or structuring of the material. For the purpose of separating, it is possible to produce series of modifications, for example, which initiate breaking within or along the modifications. Furthermore, it is known, for the purpose of separating, drilling and structuring, to generate modifications which enable selective etching of the modified regions (SLE: selective laser etching).

An elongated focus zone can be produced e.g. with the aid of apodized Bessel beams (also referred to herein as quasi-Bessel beams). An elongated focus zone extends along a focus zone axis and, in the case of quasi-Bessel beams, is formed by constructive interference of laser radiation which passes at an angle with respect to the focus zone axis.

Quasi-Bessel beams can be shaped for example by an axicon or a spatial light modulator (SLM) and an incident laser beam with a Gaussian beam profile. Subsequent imaging into a transparent workpiece results in the intensities required for the volume absorption in the elongated focus zone. Quasi-Bessel beams—like Bessel beams—usually have a ring-shaped intensity distribution in the far field. A distinction is drawn between focus zones which have a defined beginning (conventional quasi-Bessel beams) and focus zones which have a defined end (inverse quasi-Bessel beams), depending on whether the beginning or the end of a focus zone is attributed to the constructive interference of laser radiation which forms the central region of the ring-shaped intensity distribution (near the focus zone axis). Furthermore, it is possible to shape the intensity distributions in the propagation direction; by way of example, the intensity profile is matched (homogenized) in so-called homogenized (inverse) Bessel beams.

Along the focus zone axis it is possible to shape the intensity profile in this respect in such a way as to produce a spatially defined transition from non-modified material to modified material in the material along the focus zone axis.

Furthermore, with Gaussian beam profiles in the propagation direction spatially delimited modifications can be produced which can be regarded as punctiform in comparison with the elongated focus zones discussed.

One aspect of this disclosure addresses the problem of enabling shaped separating edge courses when separating an at least partly transparent material into a plurality of workpieces. In particular, the problem addressed is that of reducing, simplifying or even avoiding post-processing steps during the processing of transparent materials.

At least one of these problems is solved by means of a method as claimed in claim 1 and by means of a laser processing apparatus as claimed in claim 14. Developments are specified in the dependent claims.

One aspect discloses a method for the laser material processing of an at least partly transparent material by sequentially modifying mutually adjoining sections of the material with pulsed laser beams. The method comprises the following steps:

generating a first pulsed laser beam, which when radiated into the material forms a first focus zone,

processing the material with the first pulsed laser beam in order to produce first modifications, wherein the first focus zone is moved relative to the material in order to modify a first section of the material, such that the first modifications form a shielding surface,

generating a second pulsed laser beam, which when radiated into the material forms a second focus zone, which is formed in elongated fashion along a second focus zone axis and is formed by constructive interference of laser radiation which passes at an angle toward the second focus zone axis, and

processing the material with the second pulsed laser beam by moving the second focus zone relative to the material in order to produce second modifications in a second section of the material, wherein at least one part of the laser radiation passing at an angle toward the second focus zone axis impinges on the shielding surface.

A further aspect discloses a laser processing apparatus for the processing of an at least partly transparent material by sequentially modifying mutually adjoining sections of the material with pulsed laser beams. The laser processing apparatus comprises a laser beam source for generating a first pulsed laser beam, which when radiated into the material forms a first focus zone, which is formed optionally as a Gaussian focus zone or a focus zone elongated along a first focus zone axis and, at a beginning and/or at an end of the first focus zone, forms an intensity rise which in the material, along the first focus zone axis, produces a spatially defined transition from non-modified material to modified material, and for generating a second pulsed laser beam, which when radiated into the material forms a second focus zone, which is formed in elongated fashion along a second focus zone axis and is formed by constructive interference of laser radiation which passes at an angle toward the second focus zone axis. The laser processing apparatus further comprises a workpiece mounting unit for mounting the material as workpiece, and a control unit configured for carrying out the method disclosed herein. In this case, the laser processing apparatus is configured for carrying out a relative movement between the material and the focus zones of the first pulsed laser beam and of the second pulsed laser beam and also for an alignment of the second pulsed laser beam with respect to the shielding surface.

In some embodiments, during the processing of the material with the second pulsed laser beam in each case the second focus zone axis can be aligned with the shielding surface in such a way that the constructive interference of the laser radiation of the second pulsed laser beam downstream of the shielding surface (115) is disturbed, in particular suppressed, such that the second pulsed laser beam (103′) forms the second modification (119′) only as far as the shielding surface (115). Optionally only a part of the second pulsed laser beam can impinge on the shielding surface, such that the constructive interference of the laser radiation of the second pulsed laser beam which impinges on the shielding surface with a part of the laser radiation of the second pulsed laser beam which does not impinge on the shielding surface is disturbed, in particular suppressed, such that the second pulsed laser beam forms the second modification (only) as far as the shielding surface and the second section preferably leads into the first section. In particular, the second focus zone axis can be tangent to the shielding surface or pass through the shielding surface.

In some embodiments, the first focus zone can be formed in elongated fashion along a first focus zone axis and, at a beginning and/or at an end of the first focus zone, can form an intensity rise which in the material, along the first focus zone axis, produces a spatially defined transition from non-modified material to modified material. The shielding surface can be delimited by the spatially defined transitions in the material, wherein the spatially defined transitions can constitute a shielding edge extending through the material. Furthermore, the second focus zone can be moved relative to the material in such a way that the second focus zone axis passes close to the shielding edge or through the shielding edge or in a spatial region extending around the shielding edge, or through the shielding surface. In this case, during the processing of the material with the second pulsed laser beam, the second pulsed laser beam can be aligned in such a way that the second focus zone in each case leads to the shielding surface and/or the second focus zone axis passes through the shielding edge. Alternatively or additionally, the transition from non-modified material to modified material in the first focus zone can be spatially delimited in such a way that the transition extends along the focus zone axis over a length in a range of between 1 μm and 200 μm, typically between 5 μm and 50 μm or between 10 μm and 30 μm.

In some embodiments, the first pulsed laser beam and/or the second pulsed laser beam can be generated in such a way that the first focus zone and/or the second focus zone (107′) have/has an aspect ratio which is at least 10:1, and/or that the first focus zone and/or the second focus zone have/has a maximum change in the lateral extent of the modification-effecting intensity distribution over the focus zone in the range of 50% or less, e.g. 20% or less, or 10% or less. Alternatively or additionally, the first pulsed laser beam and/or the second pulsed laser beam can be generated in such a way that the first focus zone and/or the second focus zone, in terms of the axial extent thereof at the beginning and/or at the end, are/is determined by a phase modulation of an incident laser beam, wherein the phase modulation is configured for forming a Bessel beam focus zone and in particular imposes on the incident laser beam an axicon phase contribution that varies in a radial direction, and wherein the phase modulation is restricted to a radial region, wherein optionally the incident laser beam, for restriction to the radial region, in a radially inner region and/or in a radially outer region, interacts with a beam stop, in particular is blocked by an amplitude stop or is scattered by a phase stop, or wherein optionally the incident laser beam is formed only in the radial region.

In some embodiments, the first focus zone can be formed with a Gaussian laser beam, such that the first modifications correspond to a Gaussian focus zone in terms of their geometry, in the material the first modifications are arranged in a grid and the grid forms the shielding surface. In this case, the second focus zone can be moved relative to the material in such a way that the second focus zone axis passes through the shielding surface or in a spatial region extending around the shielding surface, or in an edge region of the shielding surface.

In some embodiments, the second pulsed laser beam when radiated into the material, at a beginning of the second focus zone, can form an intensity rise which in the material, along the second focus zone axis, produces a spatially defined transition from non-modified material to modified material, such that material regions which were modified by laser pulses of the second pulsed laser beam form a further shielding surface delimited by the spatially defined transitions in the material, wherein the spatially defined transitions constitute a further shielding edge extending through the material. Furthermore, the method can comprise the following steps:

generating a third pulsed laser beam, which when radiated into the material forms a third focus zone, which is formed in elongated fashion along a third focus zone axis and is formed by constructive interference of laser radiation which passes at an angle toward the second focus zone axis, and

processing the material with the third pulsed laser beam by moving the third focus zone relative to the material in order to modify a third section of the material in such a way that the third focus zone axis passes close to the further shielding edge or through the further shielding edge.

In some embodiments, the first section and the second section can at least partly form a separating contour surface in the material. Furthermore, the method can comprise: separating the material along the separating contour surface, wherein in particular the first section or the second section results in the formation of a long bevel or a microbevel and/or wherein the first section and the second section result in the formation of a cutout in the material. By way of example, the second section can define a connection surface which merges into the shielding surface, such that after the material has been separated into two parts, at one of the parts an edge forms along the spatially defined transitions.

In some embodiments, the second pulsed laser beam and optionally the first pulsed laser beam can have a quasi-Bessel-beam-like beam profile in which in particular only a central region of the incident laser radiation makes contributions to an upstream end of the elongated focus zone. Furthermore, the second pulsed laser beam and optionally the first pulsed laser beam can have an inverse quasi-Bessel-beam-like beam profile in which in particular only a central region of the incident laser radiation makes contributions to a downstream end of the elongated focus zone.

In some embodiments of the laser processing apparatus, the control unit can be configured for setting a position of the focus zone, in particular a position of an end of the elongated focus zone, in relation to the workpiece mounting unit and/or for setting a parameter of the laser beam. Additionally or alternatively, the laser beam source can furthermore be configured to generate laser radiation which modifies the material by nonlinear absorption.

The laser processing apparatus can furthermore comprise an optical system having a beam shaping element, wherein the beam shaping element is configured for imposing a transverse phase profile on incident laser radiation. In particular, the optical system can be configured for producing an elongated focus zone with an aspect ratio of at least 10:1 and/or with a maximum change in the lateral extent of the intensity distribution over the focus zone in the range of 50% or less. Alternatively or additionally, the optical system can be configured for forming an elongated focus zone in which only a central region of the laser beam makes contributions to an upstream or downstream end of the elongated focus zone.

A spatially defined transition for the beginning or end of a modification section—in particular for the formation of a shielding edge by means of the modifications forming the modification section—can be obtained with the aid of a very rapid intensity rise or intensity fall in the focus zones. In particular, a rapid intensity rise/fall can effect a spatially well-defined beginning or a spatially well-defined end of the modification, wherein this can be supported by nonlinear absorption and modification processes. Nevertheless it may be difficult to form a “hard” beginning/“hard” end of a modification or to coordinate them with one another in the case of mutually adjoining modification sections.

For the formation of such transitions, embodiments of the invention utilize the aspect of interference during the focus formation of a quasi-Bessel beam. In this regard, it has been recognized that a previously written modification plane can be utilized for shielding in order to suppress the constructive interference during the formation of a modification downstream of the written modification plane.

The concepts disclosed herein enable advantages such as laser processing without, in particular dirty, post-processing steps and also very rapid shaping methods in comparison with shaping methods that use grinding processes.

Concepts which allow aspects from the prior art to be improved at least in part are disclosed herein. In particular, further features and their expediencies will become apparent from the following description of embodiments with reference to the figures.

Aspects described herein are based in part on the insight that it is not possible for start and end points of different modifications to be strung together exactly if the intensity along the focus zone axis within the focus zone rises and falls again relatively shallowly in a typical manner. The inventors have recognized that in the case of focus zones formed by constructive interference of converging beam portions, a previously produced modification can influence the interference. In this regard, it has been recognized that particularly in the case of spatially rapid transitions from modified material to non-modified material, even just one beam portion can be influenced by the previously produced modification, as a result of which the interference can be reduced or avoided. In summary, one modification can be used to spatially delimit the formation of a further modification.

Aspects described herein are furthermore based in part on the insight that a lateral energy supply into an elongated focus zone can be actively suppressed by shielding effects that influence the constructive interference.

The systems and methods arising from these insights can make it possible, inter alia, to separate transparent, hard brittle materials at high speed and with good quality of the cut edge.

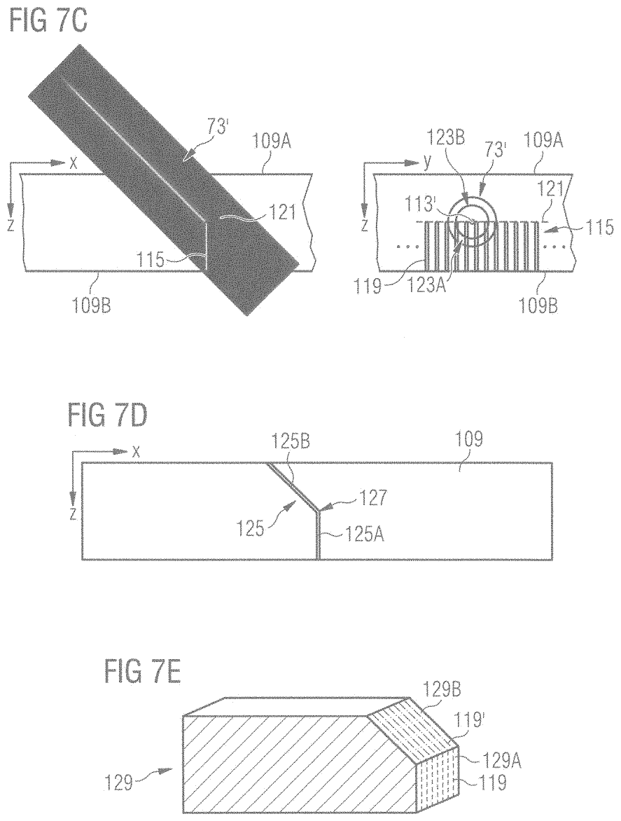

The underlying optical system will be explained in general below with reference to FIGS. 1 to 6. Exemplary embodiments of the laser material processing of an at least partly transparent material by sequentially modifying mutually adjoining sections of the material with pulsed laser beams will be described afterward (see FIGS. 7A to 10B). FIG. 11 additionally elucidates the influencing of the axial extent of an elongated focus zone by a beam stop in the phase imposing region.

FIG. 1 shows a schematic illustration of a laser processing apparatus 1 comprising a laser beam source 1A and an optical system 1B for the beam shaping of a laser beam 3 of the beam source 1A with the aim of producing a focus zone 7 formed in elongated fashion along a first focus zone axis 5 in a material 9 to be processed. The laser processing apparatus 1 can furthermore have a beam aligning unit and a workpiece mounting unit (not shown explicitly in FIG. 1).

In general, the laser beam 3 is determined by beam parameters such as wavelength, spectral range, pulse shape over time, formation of pulse groups, beam diameter and polarization. The laser beam 3 will usually be a collimated Gaussian beam with a transverse Gaussian intensity profile, said beam being generated by the laser beam source 1A, for example an ultrashort-pulse high-power laser system. From the Gaussian beam the optical system 1B shapes a beam profile which makes it possible to form the elongated focus zone 7; by way of example, a customary or inverse Bessel-beam-like beam profile is produced by a beam shaping element 11, which for imposing a transverse phase profile on the incident laser radiation is configured e.g. as a hollow-cone axicon, a hollow-cone axicon lens/mirror system, a reflective axicon lens/mirror system or a, in particular programmable or permanently written, diffractive optical element, in particular as a spatial light modulator. For exemplary configurations of the optical system, reference is made to WO 2016/079062 A1, cited in the introduction.

The elongated focus zone 7 herein relates to a three-dimensional intensity distribution which is determined by the optical system 1B and which determines in the material 9 to be processed the spatial extent of the interaction and thus of the modification with a laser pulse/laser pulse group. The elongated focus zone 7 thus determines an elongated region in which a fluence/intensity lying above the threshold fluence/intensity relevant to the processing/modification is present in the material to be processed.

Transparency of a material herein relates to the linear absorption. For light below the threshold fluence/intensity, a “substantially” transparent material can absorb e.g. less than 20% or even less than 10% of the incident light for example on a length of the modification.

Elongated focus zones is the term usually used if the three-dimensional intensity distribution with respect to a target threshold intensity is characterized by an aspect ratio (ratio of the extent in the propagation direction to the lateral extent transversely with respect to the focus zone axis (diameter of the on-axis maximum)) of at least 10:1, for example 20:1 or more, or 30:1 or more, or 1000:1 or more. Such an elongated focus zone can result in a modification of the material with a similar aspect ratio. In general, in the case of such aspect ratios, a maximum change in the lateral extent of the intensity distribution which effects a modification over the focus zone can be in the range of 50% or less, for example 20% or less, for example in the range of 10% or less.

In this case, in an elongated focus zone, the energy can be supplied laterally substantially over the entire length of the focus zone. This has the consequence that a modification of the material in the initial region of the focus zone has no or at least hardly any shielding effects on the part of the laser radiation which effects a modification of the material downstream, i.e. e.g. in the region of the focus zone.

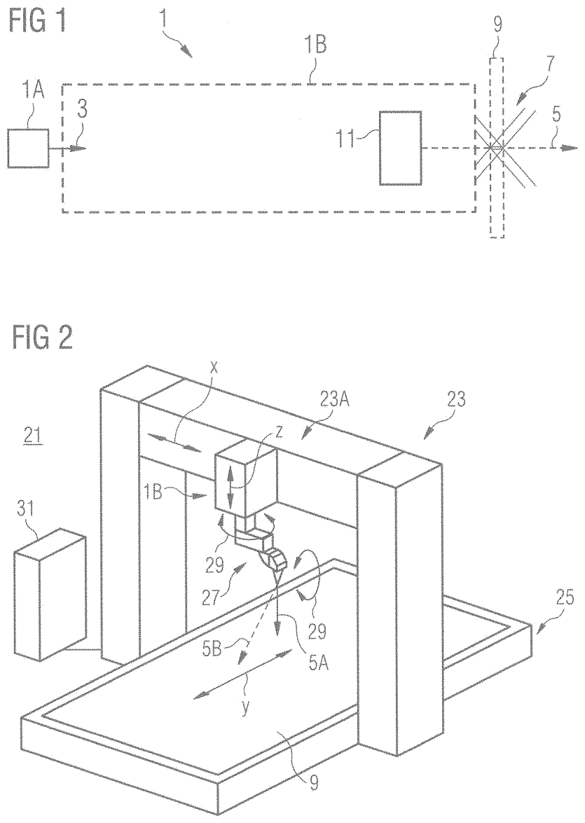

FIG. 2 shows an exemplary set-up of a laser processing apparatus 21 for material processing. The laser processing apparatus 21 has a carrier system 23 (as part of a beam aligning unit) and a workpiece mounting unit 25. The carrier system 23 spans the workpiece mounting unit 25 and carries the laser beam source, for example, which in FIG. 2 is integrated for example in an upper cross member 23A of the carrier system 23. Furthermore, the optical system 1B can be attached to the cross member 23A movably in the X-direction. In alternative embodiments, for example, a laser system can be provided as a dedicated external beam source, the laser beam 3 of which is guided to the optical system by means of optical fibers or as a free beam.

The workpiece mounting unit 25 carries a workpiece extending in the X-Y-plane. The workpiece is the material 9 to be processed, for example a sheet of glass or a sheet that is largely transparent to the laser wavelength used, made of a ceramic or crystalline material, such as for example sapphire or silicon. The workpiece mounting unit 25 allows moving of the workpiece in the Y-direction in relation to the carrier system 23, so that, in combination with the movability of the optical system 1B, a processing region extending in the X-Y-plane is available.

In accordance with FIG. 2, furthermore, displaceability in the Z-direction e.g. of the optical system 1B or of the cross member 23A is provided in order to be able to set the distance with respect to the workpiece. For a cut extending in the Z-direction, the laser beam is usually also directed onto the workpiece in the Z-direction (i.e. normal to it) (focus zone axis 5A in FIG. 2). Further processing axes, indicated in FIG. 2 by way of example by a cantilever arrangement 27 and additional rotation axes 29, allow the emerging laser beam and thus the focus zone axis to be aligned in space. A focus zone axis 5B inclined with respect to the X-Y-plane is indicated by way of example in FIG. 2.

The laser processing apparatus 21 furthermore has a control unit 31, which has in particular an interface for the inputting of operating parameters by a user. Generally, the control unit 31 comprises elements for controlling electrical, mechanical and optical components of the laser processing apparatus 21, for example by controlling corresponding operating parameters of the laser system, such as e.g. pumping laser power, and the workpiece mounting, electrical parameters for the setting of an optical element (for example an SLM) and parameters for the spatial alignment of an optical element (for example for rotating the focus zone axis).

Exemplary laser beam parameters for e.g ultrashort pulse laser systems and the elongated focus zone which can be used within the scope of this disclosure are:

pulse energy Eₚ: 1 μJ to 20 mJ (for example 20 μJ to 1000 μJ),
energy of a pulse group E_{g}: 1 μJ-20 mJ
wavelength ranges: IR, VIS, UV (for example 2 μm>λ>200 nm; for example 1550 nm, 1064 nm, 1030 nm, 515 nm, 343 nm)
pulse duration (FWHM): 10 fs to 50 ns (for example 200 fs to 20 ns)
exposure time (dependent on advancing rate): less than 100 ns (for example 5 ps-15 ns)
duty cycle (ratio of exposure time to repetition time of the laser pulse/pulse group): less than or equal to 5%, for example less than or equal to 1%
raw beam diameter D (1/e²) when entering the optical system: for example in the range of 1 mm to 25 mm
length of the beam profile (of the focus zone) in the material: greater than 20 μm
maximum lateral extent of the beam profile in the material, possibly in the short direction: less than 20λ
aspect ratio: greater than 20
advancement dᵥ between two adjacent modifications, for example for use in separating: 100 nm<dᵥ<10*lateral extent in advancing direction
advancement during exposure time: for example less than 5% of the lateral extent in the advancing direction

The pulse duration relates here to a laser pulse and the exposure time relates to a time range in which for example a group of laser pulses for forming a single modification at one location interacts with the material. The exposure time is short here with respect to an advancing rate present, so that all of the laser pulses of a group contribute to a modification at one location.

The abovementioned parameter ranges may allow the processing of material thicknesses of up to, for example, 5 mm or more (typically 100 μm to 1.1 mm). For further details of an exemplary laser processing apparatus, reference is made to WO 2016/079062 A1, cited in the introduction.

It is generally true for the processing of transparent materials by means of elongated volume absorption that, as soon as an absorption takes place, this absorption itself, or else the resultant changing of the material property, can influence the propagation of laser radiation. Therefore, it is advantageous to feed the beam portions that serve for the modification further downstream of the beam to the zone of interaction at an angle with respect to the focus zone axis. One example of this is the (conventional) quasi-Bessel beam, in the case of which there is a ring-shaped far field distribution, the ring width of which is typically small in comparison with the radius. Radial beam portions are fed to the zone of interaction/focus zone axis in this case substantially at this angle rotationally symmetrically. The same applies to the inverse quasi-Bessel beam and to modifications such as homogenized or modulated (inverse) quasi-Bessel beams.

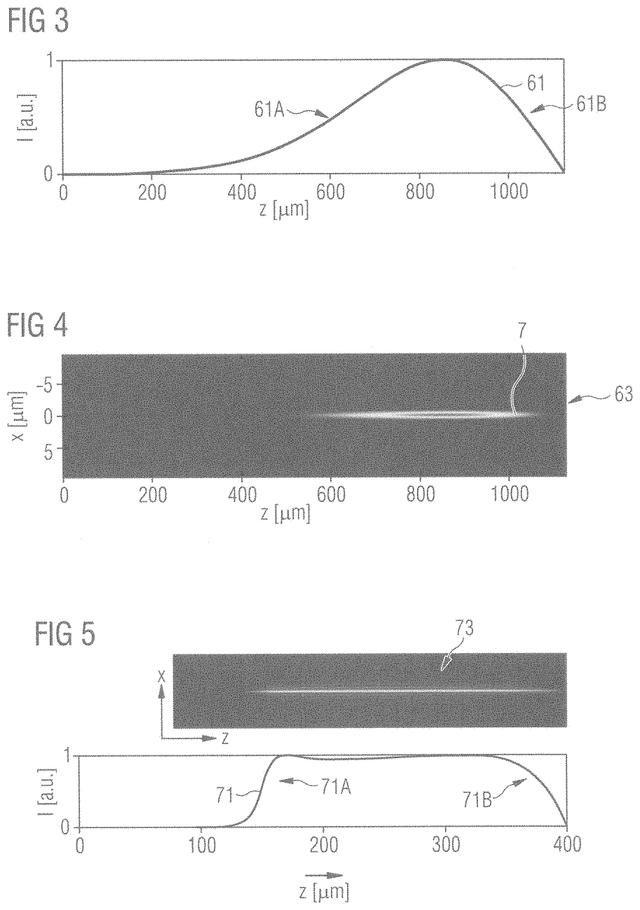

FIG. 3 clarifies by way of example a longitudinal intensity distribution 61 such as may be present in the elongated focus zone 7. The intensity distribution 61 was calculated for an inverse quasi-Bessel beam shape. A normalized intensity I in the Z-direction is plotted. It should be noted that a propagation direction in accordance with normal incidence (in the Z-direction) on the material 9 is not mandatory and, as explained in association with FIG. 2, can alternatively be implemented at an angle with respect to the Z-direction.

FIG. 3 reveals an initially slow intensity rise 61A over several 100 micrometers (initial superposition of the low (outer) intensities of the Gaussian incident beam) up to an intensity maximum, followed by a sharp intensity fall 61B (superposition of the high (central) intensities of the Gaussian incident beam). For an inverse Bessel beam shape, a hard limit (fixed end) of the longitudinal intensity distribution 61 arises in the propagation direction (Z-direction in FIG. 4). This hard limit is based on the fact that the end of the longitudinal intensity distribution 61 is attributed to the contributions of the beam center of the incident laser beam. For further details concerning the inverse Bessel beam shape, reference is made to WO 2016/079062 A1, cited in the introduction.

FIG. 4 shows an exemplary X-Z-section 63 of the intensity in the focus zone 7 for the longitudinal intensity distribution 61 shown in FIG. 3. It is noted that the grayscale representations in FIG. 4 are based on a color representation, such that the maximum values of the intensity/amplitude in the center of the focus zone have been represented dark. The elongated formation of the focus zone 7 over several 100 micrometers with a transverse extent of a few micrometers is evident. With the threshold value behavior of the nonlinear absorption, such a beam profile in the workpiece can effect a clearly defined elongated modification, accompanied by a spatially defined transition from non-modified material to modified material. The elongated shape of the focus zone 7 has for example an aspect ratio, i.e. a ratio of the length of the focus zone to a maximum extent, occurring within this length, in the laterally shortest direction usually of the central maximum, in the range of 10:1 to 1000:1, e.g. 20:1 or more, for example 50:1 to 400:1.

In addition, it is possible to utilize an intensity modification in the propagation direction (Z-direction). In this case, it is possible to produce for example a longitudinal flat top intensity profile 71 over a freely selectable length in the Z-direction (in FIG. 4 by way of example a length range of approximately 200 μm in the Z-direction), as is indicated in FIG. 5 together with an X-Z-section of an exemplary intensity distribution 73 in the focus zone 7.

In order to homogenize the intensity in the Z-direction, diffractive optical elements can perform a digitized and e.g. pixel-based phase adaptation over an incident input intensity profile. Proceeding from the intensity profile of an inverse quasi-Bessel beam shape, it is possible to produce for example the longitudinal flat top intensity profile 71 shown in FIG. 5 in the focus zone 7. For this purpose, intensity contributions in the output intensity profile can be extracted from the region forming the intensity maximum and the tails of the Bessel beam and can be radially redistributed by means of a phase change in such a way that during the later focusing an intensity rise 71A and an intensity fall 71B are spatially shortened (e.g. by shifting power from the tails into the homogenized region).

In the region of the intensity rise 71A, FIG. 5 shows a rise from 20% to 80% of the maximum intensity in a few 10 μm. In combination with nonlinear absorption, a spatially defined transition from non-modified material to modified material can thus be produced in the material along the first focus zone axis.

In the case of inverse quasi-Bessel-beam-like beam shapes modified in this way, too, the end of the modification is substantially stationary in terms of its position in the beam propagation direction, since this position is supplied with energy by the beam center of the incident laser beam.

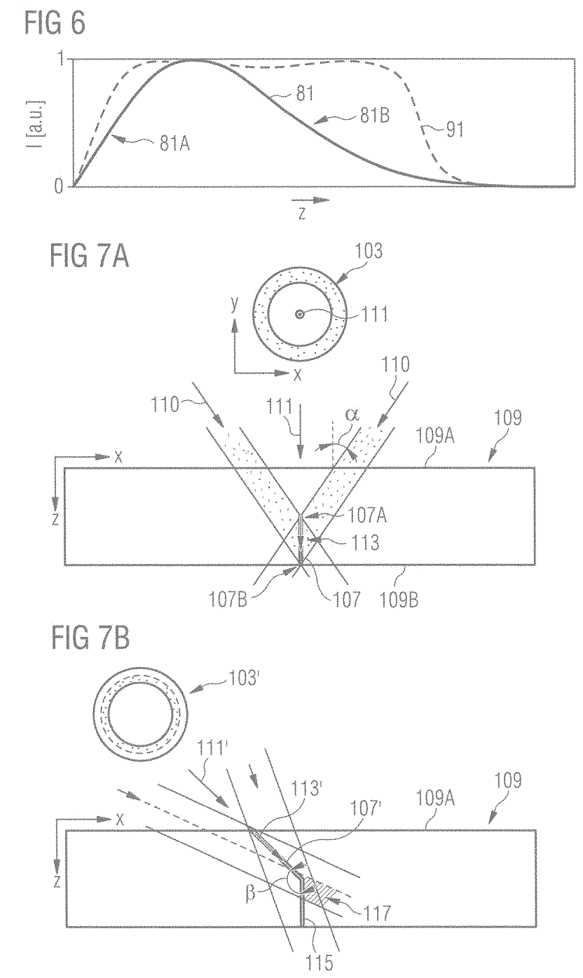

FIG. 6 clarifies a longitudinal intensity distribution 81 in the Z-direction of a (conventional) quasi-Bessel beam. After an initially sharp rise 81A, an intensity maximum is reached, from which the intensity falls again. At low intensities a slowly tailing-off fall 81B commences (tailing-off fall with a small gradient). The fundamental inversion of the longitudinal intensity distributions 61 and 81 from FIG. 3 is evident, in the case of which the “hard limit” at the end is replaced by a “hard beginning”.

For such a quasi-Bessel beam, e.g. the transmission through an axicon of a laser beam incident with a Gaussian beam profile will result in constructively superposed (interfering) beam regions along the focus zone axis. A superposition (constructive interference) of the intensities of the central region of the Gaussian beam profile takes place first, then a superposition (constructive interference) of the low (outer) intensities of the Gaussian beam profile.

FIG. 6 furthermore shows, similarly to FIG. 5, a longitudinal flat top intensity profile 91 in the Z-direction of a modified (conventional) quasi-Bessel beam which was homogenized in terms of its intensity along the focus zone. In this case, FIG. 6 in turn shows a fall from 80% to 20% of the maximum intensity in a few micrometers. In combination with nonlinear absorption, a spatially defined transition from modified material to non-modified material can thus be produced in the material along the first focus zone axis.

For further details concerning the Bessel beam shape, in particular the beam homogenization, reference is made to WO 2016/079275 A1 in the name of the present applicant.

In this context, reference is additionally made to the possibilities elucidated in FIG. 11 for setting the beginning and/or end of an elongated focus zone of a quasi-Bessel beam.

As explained above and in association with FIG. 11, pulsed laser beams can thus be generated which when radiated into a partly transparent material can form focus zones which are formed in elongated fashion along a focus zone axis and, at a beginning and/or at an end of the focus zone (along the focus zone axis), form an intensity rise/fall which produces an in particular spatially well-defined transition from non-modified material to modified material, and vice versa, in the material along the focus zone axis. The transition can extend along the focus zone axis over a length in a range of between 1 μm and 200 μm, typically between 10 μm and 30 μm.

Additionally or alternatively, the pulsed laser beams can form focus zones by way of constructive interference of laser radiation, which pass at an angle with respect to the focus zone axis.

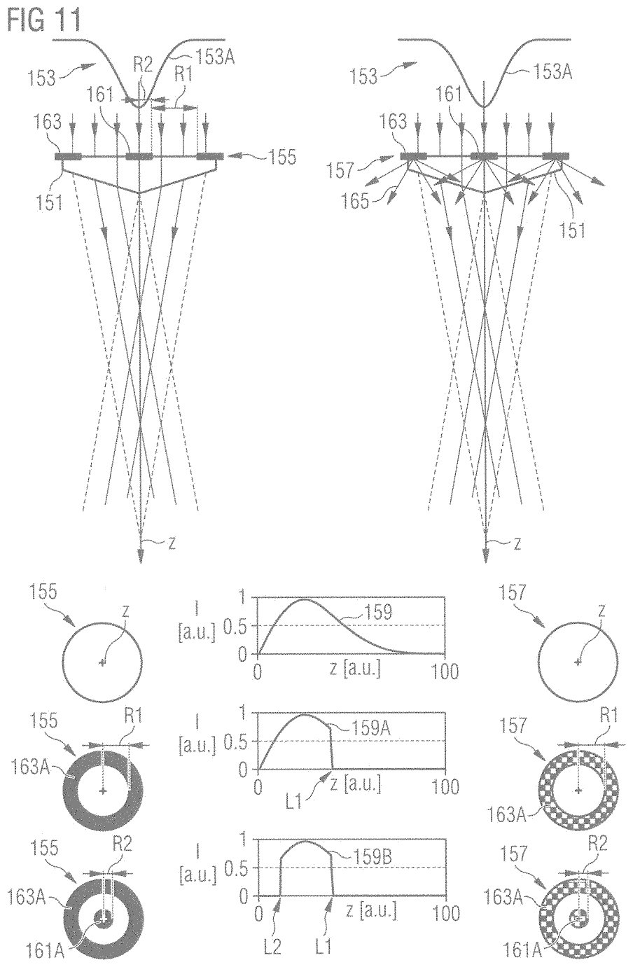

Laser material processing of an at least partly transparent material can be effected by sequentially modifying mutually adjoining sections of the material with such pulsed laser beams (and elongated focus zones) in a plurality of steps implemented below in association with FIGS. 7A to 7C. As will furthermore be explained in association with FIG. 10B, it is not necessary to generate laser beams which bring about all sections with such elongated focus zones, rather sections can also be formed with localized, for example Gaussian, focus zones.

Processing for separating a material into two parts will be described as an example, the intention being to provide a one-sided bevel on one of the parts with respect to the separating surface. This is done by introducing a perpendicular modification and one positioned with respect thereto.

FIG. 7A shows, in a schematic sectional view, how an elongated (first) focus zone 107 can be produced in a material 109 with a pulsed laser beam 103 having by way of example an (inverse) Bessel beam profile produced by an axicon optical unit. FIG. 7A furthermore schematically illustrates the Bessel beam profile as a ring-shaped transverse intensity distribution (intensity ring) lying in the X-Y-plane. A propagation direction 111 of the laser beam 103 runs perpendicular to a top side 109A of the material 109 in the Z-direction. The intensity ring, as indicated by arrows 110, passes at an angle α toward the focus zone axis in the material 109, such that the different radial zones can interfere with one another. Accordingly, as a result of constructive interference of the different radial zones, the elongated focus zone 107 forms for example rotationally symmetrically along a focus zone axis 113 in the material 109.

The intensity of the laser radiation is chosen in such a way that as a result of volume absorption a modification of the material 109 takes place in a region corresponding to the focus zone 107 illustrated.

The position of the focus zone 107 is set in such a way that a beginning 107A of the focus zone 107 lies in the interior of the material 109, thus resulting in a spatially defined transition from non-modified material to modified material along the focus zone axis 113. In particular, the Bessel beam profile can be modulated so as to result in a sharp starting point (beginning 107A) for the modification in the material 109. In this case, an end 107B of the focus zone 107 ends for example at an underside 109B of the material 109.

If the focus zone 107 is moved relative to the material 109 along the Y-direction, for example, a modification of a first section of the material takes place. For the laser pulses of the pulsed laser beam 103 modified regions (elongated modifications) arranged next to one another arise in the material 109. The correspondingly areally arising modification of the material 109 is already used for the later separation, but it is also used for shielding laser radiation in a subsequent processing step.

The modified section in this sense forms a shielding surface extending in the Y-Z-plane. The shielding surface is delimited by the spatially defined transitions in the material in the Z-direction, such that the spatially defined transitions constitute a shielding edge extending through the material 109 in the Y-direction. Shielding herein relates to a presence of modifications which affect the propagation of laser radiation. The shielding surface projects (at least partly) into an optical beam path in order to influence the propagation of laser radiation, in particular in order to disturb a phase relationship with respect to interference that otherwise occurs. In this sense the shielding surface can also be referred to herein as an interference disturbing surface.

FIG. 7B shows how, in a second processing step, a second areal modification can be introduced into the material 109 at an angle ß in relation to the first areal modification. The angle ß corresponds to a desired bevel angle of the separating surface to be obtained.

The first areal modification is indicated as a shielding surface 115 in the sectional view in FIG. 7B. FIG. 7B furthermore shows a pulsed laser beam 103′ with a ring-shaped intensity distribution, this time the laser beam 103′ impinging on the top side 109A of the material 109 at a corresponding angle. A corresponding propagation direction 111′ is indicated in FIG. 7B.

As a result of constructive interference of radial beam regions, an elongated focus zone 107′ is formed along a focus zone axis 113′. In this case, the beam parameters of the laser beam 103′ are chosen in such a way that in the absence of the shielding surface 115 a focus zone which would go beyond the position thereof could result. In other words, a modification with the pulsed laser beam 103′ could extend across the position of the shielding edge, but the propagation of the laser radiation is influenced by the shielding surface 115 already present.

By way of example, the second pulsed laser beam 103′ (during the processing of the material 109) can be aligned in such a way that the second focus zone 107′ for each laser pulse leads to the shielding surface 115 and/or the second focus zone axis 113′ passes through or close to the shielding edge 121.

After the point of intersection between focus zone axis 113′ and shielding surface 115, constructive interference no longer occurs. The continuation of the elongated focus zone across the shielding surface 115 is thus prevented and the formation of a corresponding modified region in the material 109 ends at the shielding surface 115.

The formation of a region 117 with disturbed interference is indicated in a dashed manner in FIG. 7B. A Bessel beam focus can no longer form in this region 117.

FIG. 7C illustrates the suppression of interference with the aid of sectional views in the X-Z-plane and respectively in the Y-Z-plane by way of example for the two-dimensional beam profile from FIG. 5. Starting from the shielding surface 115, regions of increased intensity can no longer be produced by constructive interference since the phase relationship between different regions of the Bessel beam profile was disturbed.

As is shown in the X-Z-sectional view in FIG. 7C, the result is a correspondingly prematurely ended intensity distribution 73′ in the focus zone. The sectional view in the Y-Z-plane as furthermore shown in FIG. 7C passes through the shielding surface 115. A plurality of modifications 119 that were produced by e.g. individual laser pulses are illustrated schematically. Each of the modifications 119 extends from the underside 109B of the material 109 as far as a spatially defined transition to non-modified material. These transitions determine the course of a shielding edge 121. In the alignment of the laser beams that is taken as a basis in FIG. 7C, the focus zone axis 113′ of the second laser beam passes in the region of the shielding edge 121.

If the material 109 is processed with the second pulsed laser beam 103′ by the second focus zone 107′ being moved relative to the material 109 in the Y-direction, this results in a second modified section of the material 109 with modified regions. The second section thus forms a connection surface which merges into the shielding surface 115.

In accordance with the concepts presented herein, here the second focus zone axis 113′ passes in each case close to the shielding edge 121 or through the shielding edge 121 (in particular in a spatial region extending around the shielding edge 121). In other words, during the processing of the material 109 with the second pulsed laser beam, in each case the second focus zone axis can be aligned with the shielding surface 115 in such a way that only a part 123A of the second pulsed laser beam 103′ impinges on the shielding surface 115, such that the constructive interference of the laser radiation of the second pulsed laser beam 103′ which impinges on the shielding surface 115 with a part 123B of the laser radiation of the second pulsed laser beam 103′ which does not impinge on the shielding surface 115 is disturbed and in particular suppressed. As a result, the second pulsed laser beam 103′ forms modified material only as far as the shielding surface 115 and the second section leads into the first section.

FIG. 7D shows in sectional view the course of the resulting (overall) modification surface 125 composed of two sections 125A and 125B. Modifications in the section 125B produced second stop at a point of intersection 127 with the section 125B produced first, as a result of which crack propagation beyond the point of intersection 127/shielding surface can be prevented during the separation of the material 109 into two parts.

FIG. 7E shows by way of example a workpiece 129 with a component geometry such as arises as a result of a separation along the modification surface 125. The workpiece has a side surface 129A (formed by the first section 125A; exemplary courses of the elongate modifications 119 of the first section 125A are indicated in a dashed manner) and a bevel surface 129B (formed by the second section 125B; exemplary courses of the elongate modifications 119′ of the second section 125B are indicated in a dash-dotted manner) adjoining the side surface 129A. It is pointed out that the modifications 119 and the modifications 119′ of successively produced sections need not merge into one another, but rather can also be introduced by radiation in a manner offset with respect to one another.

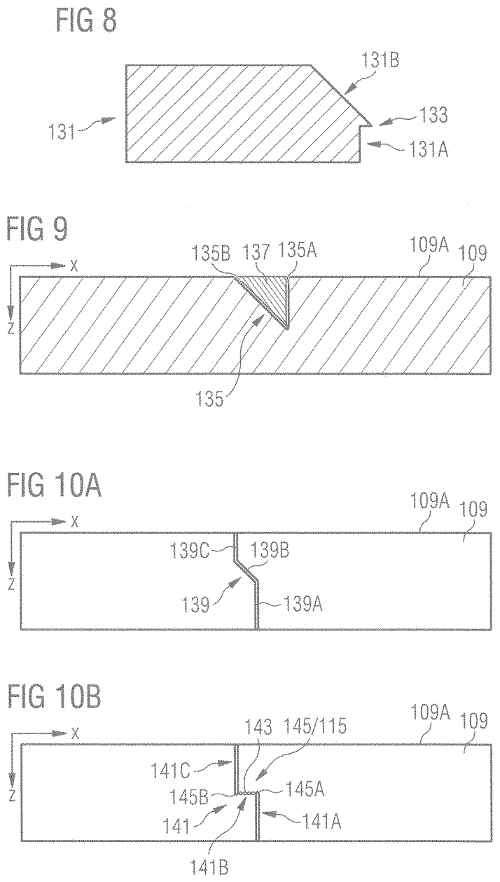

In contrast to the workpiece 129, FIG. 8 shows a schematic sectional view of an exemplary workpiece 131 in which the focus zones were not coordinated with one another and introduced by radiation in a manner according to embodiments of the invention. In the case of the workpiece 131, the transition from a side surface 131A to an adjoining bevel surface 131B has projecting residual material 133, which has to be removed subsequently.

FIGS. 9, 10A and 10B show further examples of the course of modifications which can be produced by sequentially modifying mutually adjoining sections of the material with pulsed laser beams.

In FIG. 9, two processing steps are performed. In the first step, a first pulsed laser beam is radiated onto the material 109 in such a way that the (first) focus zone projects into the material 109 from the top side 109A of the material 109 in the Z-direction. In this case, the intensity distribution along the focus zone axis is formed for example in accordance with the longitudinal flat top intensity profile 91 as shown in FIG. 6. Accordingly, the intensity undergoes a rapid fall at the end of the focus zone, such that a spatially defined transition from modified material to non-modified material is produced at the end of the focus zone. Alternatively, reference is made to FIG. 11 for producing a predetermined penetration depth of the (first) focus zone.

In the second step, a pulsed laser beam is radiated in, as has also been explained in association with FIG. 7B. In contrast to the shielding effect explained in association with FIG. 7C, the section 135A produced affects that part of the laser radiation of the second pulsed laser beam which is near the top side. The shielding has once again the (same) effect that the individual modifications (and thus the section 135B) do not form beyond the shielding surface.

As a result, the sections 135A and 135B form a wedge-shaped indentation on the top side 109A of the material 109 (as an example of a cutout in the material 109) along an (overall) modification surface 135 after residual material 137 demarcated from the modification surface 135 has been detached from the material 109.

FIG. 10A clarifies laser material processing with a sequence of three processing steps. For the production of the first two sections 139A and 139B, reference is made to the description of FIGS. 7A to 7C. With regard to the section 139B, however, a focus zone is used whose beginning lies in the interior of the material 109 and which does not penetrate into the material through the top side 109A. For producing a spatially defined transition from non-modified material to modified material in the section 139B, it is possible for example once again to use a homogenized intensity distribution such as was described in association with FIG. 5.

In order to connect the beginning of the section 139B to the top side 109A of the material 109, by way of example in the Z-direction a third pulsed laser beam was radiated in, in which case now the second modified section can act as a shielding surface if the focus zone axis of the third laser beam is correspondingly aligned with the assigned shielding edge.

Displacing the focus zone of the third pulsed laser beam in the Y-direction results in a third section 139C extending in the Z-direction. The sections 139A-139C form an (overall) modification surface 139, the course of which determines the separating contour surface.

A side surface of a workpiece with a beveled step results after separation has been carried out along the (overall) modification surface 139.

FIG. 10B clarifies laser material processing with a sequence of three processing steps. For the production of a first and a last introduced section 141A and 141C of modifications, reference is made to the description of FIG. 10A and the sections 139A and 139C.

After the section 141A has been introduced by a laser beam with a Bessel beam profile (Bessel laser beam), a Gaussian beam with a correspondingly localized Gaussian beam focus zone is used for a (transition) section 141B. If the intensity of the laser beam is high enough, modifications 143 are introduced into the material 109 substantially with the geometry of the Gaussian beam focus zone. FIG. 10B shows a lining up of modifications 143 in the X-direction.

Corresponding modifications are produced in the Y-direction, too, in the material 109. In contrast to the use of a Bessel beam focus zone, the formation of the shielding surface 115 with a Gaussian focus zone necessitates an at least two-dimensional scanning movement of the Gaussian laser beam. The Gaussian focus zone is localized in comparison with the Bessel beam focus zone, already extending two-dimensionally in elongate fashion, and effects a modification of the material structure in a quasi-punctiform manner.

As a result, the modifications 143 form a grid 145, which in FIG. 10B, by way of example, lies in a plane and forms the section 141B. The plane of the grid 145 can extend e.g. parallel or at a small angle with respect to the surface 109A of the material 109. This would not be possible e.g. for the section 139B formed with Bessel beam focus zones in FIG. 10A. Since the grid 145 is formed by “punctiform” Gaussian beam focus zones, the spatial profile of the grid 145 can be set freely, in which case the previously produced focus zones preferably do not influence the laser beam during the focus formation. By way of example, the grid 145 can form a curved or multiply curvate plane.

In the example in FIG. 10B, a first margin 145A of the grid 145 lies in the initial region of the modifications lying in the section 141A. The grid 145 furthermore extends in strip-shaped fashion in the X-Y-plane along the section 141A and thus defines the depth of a step in the example in FIG. 10B.

In order to connect the grid 145 to the top side 109A of the material 109, a pulsed Bessel laser beam is radiated in by way of example in the Z-direction as in FIG. 10A. Said laser beam now forms modifications, in which case now the second modified section 141B, i.e. the grid 145 of modifications 143, acts as a shielding surface if the focus zone axis of the Bessel laser beam is correspondingly aligned with a second margin 145B of the grid 145.

Displacing the focus zone of the Bessel laser beam in the Y-direction results in the third section 141C extending in the Z-direction as in FIG. 10A. The sections 141A-141C form the (overall) modification surface 141, the course of which determines a stepped separating contour surface. On account of the suppression of the interference necessary for the formation of the Bessel beam focus zone by the grid 145, the separating planes of the third section 141C do not project beyond the separating plane of the second section 141B formed by the grid 145.

A side surface of a workpiece with a 90° step results after separation has been carried out along the (overall) modification surface 141.

The flexibility when producing a Bessel beam focus zone with a Bessel beam is explained below in association with FIG. 11. A Bessel beam focus zone extends along a focus zone axis (by way of example in FIG. 11 the Z-axis through the axicon axis) with a substantially constant intensity profile (see FIG. 6).

Referring to the upper part of FIG. 11, a Bessel beam focus zone can be produced by an axicon 151 or a spatial light modulator that produces the phase profile of an axicon. In FIG. 11, an incident laser beam 153 having a Gaussian beam profile 153A (Gaussian laser beam) impinges on the axicon 151.

On account of the phase contribution of the axicon 151 that varies in a radial direction, downstream of the axicon 151 laser radiation passes toward the beam axis, such that interference of the radially entering laser radiation can occur along the focus zone axis. Therefore, regions at different radial distances from the focus zone axis gradually interfere along the focus zone axis.

Referring to the lower part of FIG. 11, exemplary intensity profiles along the focus zone axis are shown in three rows. In this case, a ring stop is used in addition to the phase imposing with an axicon in order to influence radial regions of the incident laser beam 153.

For this purpose, two types of ring stops are clarified in FIG. 11. The left-hand side of FIG. 11 concerns the use of an amplitude stop 155, and the right-hand side of FIG. 11 concerns the use of a phase stop 157. The position of these ring stops 155, 157 is indicated in the upper part of FIG. 11 by way of example on the incidence side of the axicon 151 (generally in the plane of the axicon/phase imposing).

An uninfluenced intensity distribution 159 is evident in the first row. This is produced only by the axicon 151; that is to say that no amplitude or phase influencing of the incident laser beam is present. The stops 155, 157 are accordingly represented only as apertures.

If radial regions of the incident laser beam 153 are then blocked (amplitude stop 155) or influenced in terms of phase (phase stop 157), the intensity distribution along the focus zone axis changes. For this purpose, the stops can be active in an inner region 161 and an outer region 163.

By way of example, a modification in the volume of a material can be ended very abruptly if the laser beam 153 illuminating the axicon 151 is blocked in the plane of the axicon 151 starting from a radius R1. In the second row, this is clarified by a black ring 163A in the outer region of the amplitude stop 155. If this outer beam region is blocked, the Bessel beam focus zone ends in an associated longitudinal plane L1 (see intensity profile 159A) since, from here on, no more laser radiation that could constructively interfere arrives at the focus zone axis. Consequently, the modification produced by the laser beam 153 also ends in the longitudinal plane L1.

The same axial delimitation of the modification can be effected if, instead of the amplitude stop 155, the power-compliant phase stop 157 is used, which puts an additional varying phase contribution on the ring-shaped beam region starting from the radius R1. This is clarified, in the upper region of FIG. 11, by scattered radiation 165 generated by the phase stop 157 in the radially outer region. In the second row in the lower region of FIG. 11, this is indicated by a checkered pattern ring 163B, which is intended to represent varying phase contributions.

With the aid of a stop in the inner region 161, similarly a modification in the volume of a material can be begun very abruptly if for example the laser beam 153 illuminating the axicon 151 is blocked in the plane of the axicon 151 as far as a radius R2. In the third row, this is clarified by an additional central black zone 161A in the inner region of the amplitude stop 155. If the inner beam region is blocked there, the Bessel beam focus zone begins at an associated longitudinal plane L2 (see intensity profile 159B) since it is only from here on that laser radiation arrives at the focus zone axis and can constructively interfere. Consequently, in the longitudinal plane L2, it is only there that the modification produced by the laser beam 153 also begins.

The same abrupt beginning of the modification can be effected if, instead of the amplitude stop 155, a power-compliant phase stop 157 is used, which puts an additional varying phase contribution on the central beam region as far as the radius R1. This, too, is clarified, in the upper region of FIG. 11, by scattered radiation 165 in the inner region 161. In the third row in the lower region of FIG. 11, this is indicated by a checkered pattern region 161B, which is intended to represent varying phase contributions.

The person skilled in the art will recognize that the abrupt beginning of a modification can also be implemented without the abrupt end. Furthermore, the axicon plane could be illuminated with a transverse flat top distribution in order to define the radial extent of the illumination in this way.

In other words, it is possible to determine the modifications proceeding from a first focus zone 107 and/or a second focus zone 107′ in terms of the axial extent thereof at the beginning and/or at the end by a phase modulation of an incident laser beam 153, wherein the phase modulation is configured for forming a Bessel beam focus zone and in particular imposes on the incident laser beam 153 an axicon phase contribution that varies in a radial direction, and wherein the phase modulation is restricted to a radial region. Optionally the incident laser beam 153, for restriction to the radial region, in a radially inner region 161 and/or in a radially outer region 163, can interact with a beam stop, in particular can be blocked by an amplitude stop and/or be scattered by a phase stop. Alternatively or supplementarily, the incident laser beam 153 can be formed only in the radial region.

It is supplementarily proposed that the focus zones delimited at the beginning and/or at the end in the propagation direction, as shown in FIG. 11, are likewise used to effect modifications delimited spatially in an axial direction and optionally to provide such delimited modifications in mutually adjoining planes/surfaces in order to produce a modification surface with a complex course in the interior of the material. In this way it is possible for example to produce modifications in a similar manner to the modifications such as have been clarified by way of example and schematically in FIGS. 7A to 10B.

Consequently, the Bessel beam focus zone with beginning/end planes L1/L2 as described in association with FIG. 11 constitute one approach which can be used as an alternative to delimiting the end by interference in accordance with the concept previously described herein or in combination with same in order to produce modifications/modification surfaces in a workpiece.

It is added that for the spatially well delineated definition of a shielding edge it is possible for example to endeavor to ensure that the intensity in the Bessel beam focus zone falls from greater than 90% to less than 10%, and/or rises, over a length in the range of 5 μm to 50 μm, for example. The fall/rise can furthermore be effected over a length in the range of five beam diameters, for example.

It is explicitly emphasized that all features disclosed in the description and/or the claims should be regarded as separate and independent of one another for the purpose of the original disclosure and likewise for the purpose of restricting the claimed invention independently of the combinations of features in the embodiments and/or the claims. It is explicitly stated that all range indications or indications of groups of units disclose any possible intermediate value or subgroup of units for the purpose of the original disclosure and likewise for the purpose of restricting the claimed invention, in particular also as a limit of a range indication.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1, 21 laser processing apparatus
1A laser beam source
1B optical system
3, 103, 103′ laser beam
5, 5A, 5B focus zone axis
7, 107, 107′ focus zone
9, 109 material
11 beam shaping element
23 carrier system
25 workpiece mounting unit
23A cross member
27 cantilever arrangement
29 rotation axes
31 control unit
61 longitudinal intensity distribution
61A intensity rise
61B intensity fall
63 X-Z-section
71 longitudinal flat top intensity profile
71A intensity rise
71B intensity fall
73, 73′ intensity distribution
81 longitudinal intensity distribution
81A sharp rise
81B tailing-off fall
91 longitudinal flat top intensity profile
107A beginning
107B end
111, 111′ propagation direction
109A top side
109B underside
110 arrows
113, 113′ focus zone axis
115 shielding surface
117 region with disturbed interference
119 modification
121 shielding edge
123A part
123B two
125, 135, 139 (overall) modification
125A, 125B, 135A, 135B, 139A-C section of the modification
127 point of intersection
129 workpiece
129A side surface
129B bevel surface
131 workpiece
131A side surface
131B bevel surface
133 residual material
137 residual material
X, Y, Z axes
I intensity
α, β angles

1. A method for laser material processing of an at least partly transparent material, the method comprising the following steps:
generating a first pulsed laser beam, which when radiated into the material forms a first focus zone,
processing the material with the first pulsed laser beam in order to produce first modifications, wherein the first focus zone is moved relative to the material in order to modify a first section of the material, such that the first modifications form a shielding surface,
generating a second pulsed laser beam, which when radiated into the material forms a second focus zone, which is formed in elongated fashion along a second focus zone axis and is formed by constructive interference of laser radiation that passes at an angle toward the second focus zone axis, and
processing the material with the second pulsed laser beam by moving the second focus zone relative to the material in order to produce second modifications in a second section of the material, wherein at least one part of the laser radiation passing at the angle toward the second focus zone axis impinges on the shielding surface.

2. The method as claimed in claim 1, wherein during the processing of the material with the second pulsed laser beam, the second focus zone axis is aligned with the shielding surface in such a way that the constructive interference of the laser radiation of the second pulsed laser beam downstream of the shielding surface is suppressed, such that the second pulsed laser beam forms the second modification only as far as the shielding surface.

3. The method as claimed in claim 1, wherein during the processing of the material with the second pulsed laser beam, only a part of the second pulsed laser beam impinges on the shielding surface, such that the constructive interference of the laser radiation of the second pulsed laser beam which impinges on the shielding surface with a part of the laser radiation of the second pulsed laser beam which does not impinge on the shielding surface is suppressed, such that the second pulsed laser beam forms the second modification only as far as the shielding surface and the second section leads into the first section.

4. The method as claimed in claim 1, wherein the second focus zone axis is tangent to the shielding surface or passes through the shielding surface.

5. The method as claimed in claim 1, wherein the first section and the second section extend at an angle in a range of 0° to 30°, with respect to one another.

6. The method as claimed in claim 1, wherein
the first focus zone is formed in elongated fashion along a first focus zone axis and, at a beginning and/or at an end of the first focus zone, forms an intensity rise in the material along the first focus zone axis, thereby producing a spatially defined transition from non-modified material to modified material,
the shielding surface is delimited by the spatially defined transition in the material, wherein the spatially defined transition forms a shielding edge extending through the material, and
the second focus zone is moved relative to the material in such a way that the second focus zone axis passes close to the shielding edge, or through the shielding edge, or in a spatial region extending around the shielding edge, or through the shielding surface.

7. The method as claimed in claim 6, wherein during the processing of the material with the second pulsed laser beam, the second pulsed laser beam is aligned in such a way that the second focus zone leads to the shielding surface and/or the second focus zone axis passes through the shielding edge.

8. The method as claimed in claim 6, wherein the transition from non-modified material to modified material in the first focus zone is spatially delimited in such a way that the transition extends along the first focus zone axis over a length in a range of between 1 μm and 200 μm.

9. The method as claimed in claim 6, wherein the first pulsed laser beam and/or the second pulsed laser beam are/is generated in such a way
that the first focus zone and/or the second focus zone have/has an aspect ratio which is at least 10:1, and/or
that, in the first focus zone and/or the second focus zone, a maximum change in a lateral extent of a modification-effecting intensity distribution over the first focus zone or the second focus zone is in a range of 50% or less.

10. The method as claimed in claim 6, wherein the first focus zone and/or the second focus zone, in terms of the axial extent thereof at the beginning and/or at the end, are/is determined by a phase modulation of an incident laser beam, wherein the phase modulation is configured for forming a Bessel beam focus zone that imposes on the incident laser beam an axicon phase contribution that varies in a radial direction, and wherein the phase modulation is restricted to a radial region, and/or
wherein the incident laser beam, for restriction to the radial region, in a radially inner region and/or in a radially outer region, interacts with a beam stop, is blocked by an amplitude stop or is scattered by a phase stop, and/or
wherein the incident laser beam is formed only in the radial region.

11. The method as claimed in claim 1, wherein
the first focus zone is formed with a Gaussian laser beam, such that the first modifications correspond to a Gaussian focus zone in terms of their geometry,
in the material, the first modifications are arranged in a grid and the grid forms the shielding surface, and
the second focus zone is moved relative to the material in such a way that the second focus zone axis passes through the shielding surface, or in a spatial region extending around the shielding surface, or in a marginal region of the shielding surface.

12. The method as claimed in claim 1, wherein the second pulsed laser beam when radiated into the material, at a beginning of the second focus zone, forms an intensity rise which in the material, along the second focus zone axis, produces a spatially defined transition from non-modified material to modified material, such that material regions which were modified by laser pulses of the second pulsed laser beam form a further shielding surface delimited by the spatially defined transitions in the material, wherein the spatially defined transitions constitute a further shielding edge extending through the material, the method further comprising:
generating a third pulsed laser beam, which when radiated into the material forms a third focus zone, which is formed in elongated fashion along a third focus zone axis and is formed by constructive interference of laser radiation which passes at an angle toward the second focus zone axis, and
processing the material with the third pulsed laser beam by moving the third focus zone relative to the material in order to modify a third section of the material in such a way that the third focus zone axis passes close to the further shielding edge or through the further shielding edge.

13. The method as claimed in claim 1, wherein the first section and the second section at least partly form a separating contour surface in the material, the method further comprising:
separating the material along the separating contour surface, wherein the first section or the second section results in a formation of a long bevel or a microbevel.

14. The method as claimed in claim 1, wherein the first section and the second section at least partly form a separating contour surface in the material, the method further comprising:
separating the material along the separating contour surface, wherein the first section and the second section result in a formation of a cutout in the material.

15. The method as claimed in claim 14, wherein the second section defines a connection surface which merges into the shielding surface, such that after the material has been separated into two parts, at one of the two parts an edge forms along the spatially defined transitions.

16. The method as claimed in claim 1, wherein the second pulsed laser beam and/or the first pulsed laser beam have a quasi-Bessel-beam-like beam profile in which only a central region of the incident laser radiation makes contributions to an upstream end of the elongated focus zone, and/or
wherein the second pulsed laser beam and/or the first pulsed laser beam have an inverse quasi-Bessel-beam-like beam profile in which only a central region of the incident laser radiation makes contributions to a downstream end of the elongated focus zone.

17. A laser processing apparatus for the processing of an at least partly transparent material, the laser processing apparatus comprising:
a laser beam source for generating a first pulsed laser beam, which when radiated into the material forms a first focus zone, which is formed as a focus zone elongated along a first focus zone axis and, at a beginning and/or at an end of the first focus zone, forms an intensity rise which in the material, along the first focus zone axis, produces a spatially defined transition from non-modified material to modified material, and for generating a second pulsed laser beam, which when radiated into the material forms a second focus zone, which is formed in elongated fashion along a second focus zone axis and is formed by constructive interference of laser radiation which passes at an angle toward the second focus zone axis,
a workpiece mounting unit for mounting the material as a workpiece, and
a control unit for carrying out the method as claimed in claim 1,
wherein the laser processing apparatus is configured for carrying out a relative movement between the material and the first focus zone of the first pulsed laser beam and the second focus zone of the second pulsed laser beam and also for an alignment of the second pulsed laser beam with respect to a shielding surface produced by the first pulsed laser beam.

18. The laser processing apparatus as claimed in claim 17, wherein the control unit is configured for setting a position of the first focus zone or the second focus zone, in particular a position of an end of the elongated first focus zone or an end of the elongated second focus zone, in relation to the workpiece mounting unit and/or for setting a parameter of the first pulsed laser beam or the second pulsed laser beam.

19. The laser processing apparatus as claimed in claim 17, wherein the laser beam source is furthermore configured to generate laser radiation which modifies the material by nonlinear absorption.

20. The laser processing apparatus as claimed in claim 17, further comprising an optical system having a beam shaping element, wherein the beam shaping element is configured for imposing a transverse phase profile on incident laser radiation, and
wherein the optical system is configured
for producing an elongated focus zone with an aspect ratio of at least 10:1 and/or with a maximum change in the lateral extent of the intensity distribution over the focus zone in the range of 50% or less, and/or
for forming an elongated focus zone in which only a central region of the laser beam makes contributions to an upstream or downstream end of the elongated focus zone.
